(19) United States
(12) Patent Application Publication
(10) Pub. No.: US 2026/0141180 A1
(43) Pub. Date: May 21, 2026

(54) DYNAMIC DATA AUGMENTATION BASED ON EXTERNAL HISTORICAL DATA

(71) Applicant: ServiceNow, Inc., Santa Clara, CA (US)

(72) Inventors: Ashwin Mishra, San Diego, CA (US); Lisa Sherilyn Henderson, Temecula, CA (US)

(21) Appl. No.: 18/952,885

(22) Filed: Nov. 19, 2024

(51) Int. Cl. G06F 40/30

(52) U.S. Cl. CPC G06F 40/30

(57) ABSTRACT

Aspects of the subject technology relate to systems, methods, and computer-readable media for generating a prompt for an artificial intelligence (AI) model by leveraging external historical records. An example method can include obtaining a trained AI model and obtaining a dataset. The example method can include obtaining a semantic value characterizing one or more words that are indicated by a user input, identifying a portion of the dataset based on the semantic value, generating an input to the AI model based on the user input and the portion of the dataset, and generating, using the AI model, a response to the user input based on the input to the AI model.

### BACKGROUND

### 1. Technical Field

The present disclosure generally relates to data augmentation, and more specifically to dynamically augmenting data for an artificial intelligence model with external historical data.

### 2. Introduction

A large language model is an artificial intelligence model trained on extensive datasets to understand and generate natural language. Large language models are designed to process and analyze large amounts of text data, enabling them to perform various natural language processing tasks such as generating and translating text, question-answering, and text completion. Training a large language model involves a series of complex processes, including collecting vast datasets, configuring a neural network, and utilizing significant computational resources. The goal of training is to enable the model to understand, predict, and generate human-like language based on patterns in the data.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure.

FIG. 1B is a block diagram illustrating an example network architecture that can be used to implement one or more aspects, components, devices, nodes, systems, instances, and/or portions of the example cloud computing architecture, according to some examples of the present disclosure.

FIG. 2 is a diagram illustrating an example system process for augmenting data for a trained artificial intelligence model with an external historical dataset, according to some examples of the present disclosure.

FIG. 3 illustrates a flow chart of an example method of augmenting data for a trained artificial intelligence model to generate a response to a user input, according to some examples of the present disclosure.

FIG. 4 illustrates a flowchart of an example method of generating an input to an artificial intelligence model based on a lack of relevant historical data, according to some examples of the present disclosure.

FIG. 5 is a diagram illustrating an example output of prediction for a vulnerability item, according to some examples of the present disclosure.

FIG. 6 is an example of a deep learning neural network that can be used to implement all or a portion of the systems and techniques described herein, according to some examples of the present disclosure.

FIG. 7 is a diagram illustrating an example architecture of an example transformer model, according to some examples of the present disclosure.

FIG. 8 illustrates an example processor-based system with which some aspects of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

As discussed previously, large language models (LLM) can be applied in a wide range of tasks that involve natural language processing (NLP). The ability to understand and generate text makes the LLMs useful in many fields, from chatbots to customer service, content generation, data analysis, and beyond. LLMs are typically trained on datasets available at the time of their development, but they are not continuously updated with recent information and do not have access to new information unless explicitly retrained with new datasets. Training LLMs requires enormous computational resources, including powerful processing units and large amounts of electricity, which makes it expensive and environmentally costly to train these models. Further, LLMs often do not perform well in specialized or domain-specific tasks that require in-depth knowledge or expertise because it is difficult to adapt LLMs for new or specific tasks without further training or fine-tuning, which can be resource-intensive.

The disclosed technology addresses the foregoing by providing an artificial intelligence (AI) model with augmented data that includes external historical data without retraining or fine-tuning the model. Specifically, the disclosed technology can identify relevant historical data based on an understanding of the semantics of word(s) associated with a user input and include the relevant historical data in an input to an AI model such as an LLM. For example, the disclosed technology can analyze an organizational database that is configured to store historical data and identify texts, items, or contents that have similar meanings or context with the words associated with user input. The identified texts, items, or contents can be embedded in an input to the model (e.g., LLM), which is configured to generate an output in response to the user input based on augmented information that includes the relevant historical data.

Furthermore, the disclosed technology can provide solutions for improving the accuracy and efficiency of predictions of an LLM by leveraging historical contextual information without having to retrain or fine-tune the model. Also, in addition to general data that an LLM has seen (e.g., been trained with), various datasets that may be limited to a specific organization (e.g., organizational historical data, policy updates, recent changes in regulations, etc.) can be utilized to generate accurate predictions.

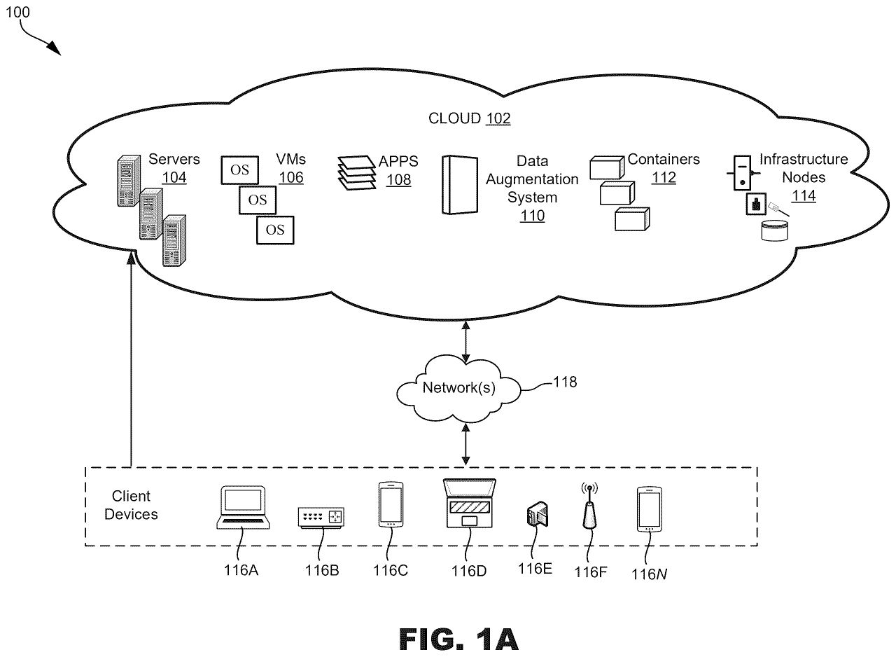

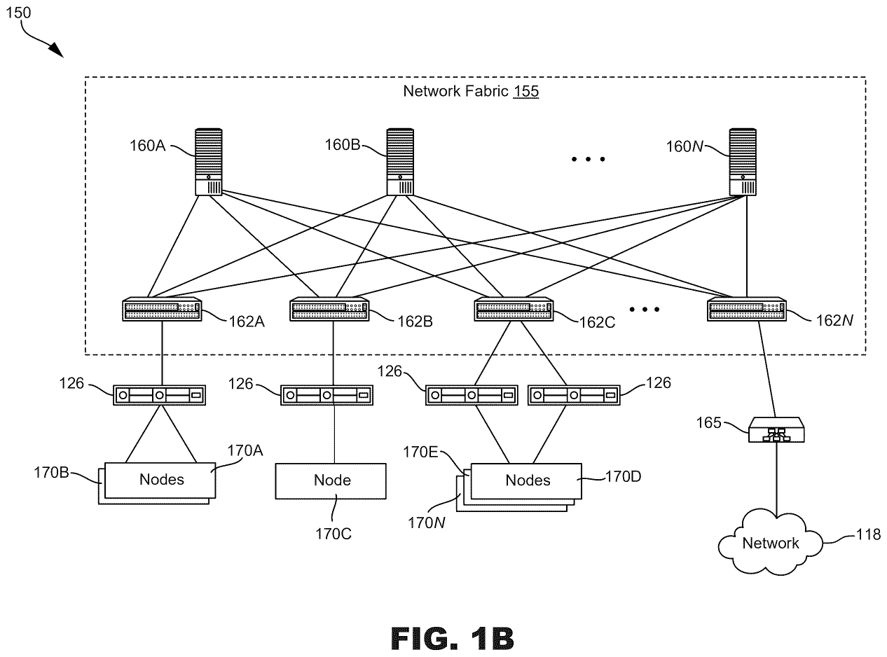

FIG. 1A illustrates a diagram of an example cloud computing environment 100 that can be used to implement a data augmentation system, according to some examples of the present disclosure. The cloud computing environment 100 can include and/or represent a cloud 102. The cloud 102 can include one or more private clouds, public clouds, and/or hybrid clouds. Moreover, the cloud 102 can include cloud elements 104-114. The cloud elements 104-114 can include or represent, for example, servers 104, virtual machines (VMs) 106, applications or services 108, data augmentation system 110, software containers 112, and/or infrastructure nodes 114. The infrastructure nodes 114 can include various types of nodes, such as compute nodes, storage nodes, network nodes, management systems, etc.

The cloud 102 can provide cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client devices 116A-N (collectively referred to as “client devices 116” hereinafter) can connect with the cloud 102 to obtain one or more specific services from the cloud 102. The client devices 116 can connect with the cloud 102 from any network of the client devices 116 such as a local area network (wired and/or wireless), a cellular network, and/or any other network, and using the network(s) 118 to transport communications between the cloud 102 and the client devices 116. For example, the client devices 116 can communicate with the cloud 102 and/or any of the elements 104-114 via a network(s) 118. The network(s) 118 can include one or more public networks (e.g., the Internet, a wide area network, etc.), one or more private networks (e.g., local area network(s), wireless local area network(s), private backbone network(s), etc.), and/or one or more hybrid networks (e.g., virtual private network(s), public and private cloud network(s), etc.).

The client devices 116 can include any device with networking capabilities, such as a laptop computer, a tablet computer, a server, a desktop computer, a smartphone, a network device (e.g., an access point, a router, a switch, etc.), a smart television, a smart car, a sensor system, a gaming console, a smart wearable device (e.g., smartwatch, etc.), an internet of things (IOT) device, a camera, a network printer, or any other computing device.

In some examples, the cloud 102 can implement data augmentation system 110 associated with one or more entities. The client devices 116 can access the data augmentation system 110 implemented and/or hosted in the cloud 102 as further described herein. An example network architecture that can be used to implement a network or datacenter (or any portion thereof), such as the cloud 102, is shown in FIG. 1B and further described below. In some cases, one or more services, components, devices, nodes, systems, instances, and/or portions of the example network architecture 150 shown in FIG. 1B can be implemented by and/or in a cloud network or datacenter, such as the cloud 102.

FIG. 1B is a block diagram illustrating an example network architecture 150 that can be used to implement one or more portions of the example cloud computing environment 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run workloads/nodes. In some cases, a cloud node can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the node can host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, the cloud 102. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126, the network device 165, and/or the nodes 170A-N (collectively referred to as “nodes 170” hereinafter) with any portion of the network fabric 155 (e.g., including each other). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g., network 118, various network elements, the network device 165, the nodes 170, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. For example, the system servers 126 can implement any of the applications 108 and/or the data augmentation system 110 hosted on the cloud 102. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170. In some examples, the nodes 170 can represent cloud instances. For example, in some cases, the nodes 170 can each represent a virtual server and/or environment (e.g., a VM, a software container, etc.) that uses compute, memory, storage, and/or networking resources on the cloud (e.g., network architecture 150) for respective workloads. For example, the nodes 170 can implement any of the applications 108 and/or data augmentation system 110 hosted on the cloud 102. In some implementations, the nodes 170 can perform parallel computing using, for example, multithreading. Each of the nodes 170 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 can represent a node instance that includes, implements, hosts, and/or runs a software container(s), an application(s), and/or a data augmentation system(s). In some examples, a software container(s) associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, and/or the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

An enterprise network and/or a data augmentation system associated with an entity can be implemented through the cloud computing environment 100 shown in FIG. 1A and the network architecture 150 shown in FIG. 1B. For example, data augmentation system 110 for augmented data for a trained AI model with external data as described herein can be implemented through the cloud computing environment 100 and/or the network architecture 150.

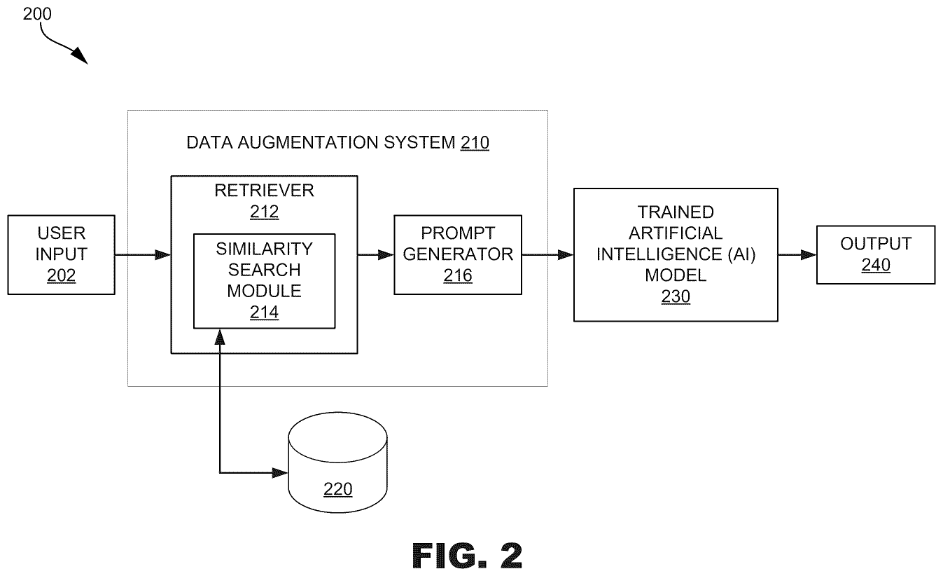

FIG. 2 illustrates an example system process 200 for generating a prompt for a trained AI model by leveraging external data. In this example, a user input 202 can be provided to a data augmentation system 210, which is configured to retrieve data from external database 220 and generate a prompt for a trained AI model 230. The prompt for trained AI model 230 includes supplementary datasets (e.g., data retrieved from external database 220) to provide trained AI model 230 with expansive and contextual data in addition to datasets that the model has been trained on. As shown, data augmentation system 210 comprises a retriever 212 for retrieving relevant data from external database 220 and a prompt generator 216 for generating a prompt for trained AI model 230 by leveraging the relevant data retrieved by retriever 212 from external database 220.

In some examples, a user (not shown) can use a client device (e.g., client device(s) 116A-116N) to provide user input 202, which may include a prompt or request in various forms such as text input, voice input, a checkbox, a button selection, etc. To illustrate an example, user input 202 can include a query (e.g., text input or a button selection) seeking information about a product or service associated with an entity. For example, user input 202 can request a prediction, remediation, preventive measure, and/or any information related to a specific vulnerable item such as a security weakness, flaw, or gap in a system, application, or network.

The data augmentation system 210 can evaluate and analyze user input 202 to determine a search query that can be used to retrieve relevant data from external database 220. For example, data augmentation system 210 can extract fields that are associated with user input 202 (e.g., title, name, description, summary, type, category, date, configuration item class, etc.). The extracted fields can be used to generate a search query for external database 220. The retriever 212 can generate a search query based on user input 202 and/or relevant fields extracted from user input 202. In some examples, a search query can be generated using a “query re-writing” approach. For example, data augmentation system 210 can identify the type of user input 202 (e.g., definition, how-to, comparison, etc.) and use keywords) to understand the user intent. Also, data augmentation system 210 can add synonyms and related items to expand search space based on lexical expansion. For example, data augmentation system 210 may, instead of an exact word for “quick,” search for “quick OR fast OR rapid.” Further, data augmentation system can add domain-specific context to incorporate user input (e.g., contextual enrichment). For example, rather than searching for “sorting algorithms,” data augmentation system 210 can look for “sorting algorithms in the context of computer science.” In some implementations, an LLM can be used to perform query re-writing to generate a search query, which can be used to retrieve relevant data from external database 220.

In some implementations, data augmentation system 210 can transform textual data in the search query or textual content associated with user input 202 into vector representations. For example, text in a search query can be converted into vectors (e.g., vector representations) such that the semantic search can be performed, based on the vector representations of the search query, to identify any datasets in external database 220 that may be relevant to the user input 202.

The retriever 212 can access external database 220, for example using a search query to obtain data that may be relevant to user input 202 or to generate a response to user input 202. The external database 220 can include one or more data storage devices implemented and/or hosted in cloud 102. The external database 220 is configured to store external knowledge such as up-to-date information, domain-specific information, entity-specific information, and so on. In some examples, external database 220 may store proprietary data that is associated with a particular entity (e.g., a business enterprise or other organization) such as updated regulations, policies specific to a particular entity, etc. For example, external database 220 can store historical records of various vulnerability items that have been found or occurred at an entity associated with user input 202 (or a user who provided user input 202). The data stored in external database 220 is different from a corpus of data that is used to train a machine learning model. For example, the trained AI model 230 has not previously seen the data stored in external database 220 such that the training data of trained AI model 230 lacks the external knowledge stored in the external database 220.

In some examples, textual content or textual data in external database 220 may be converted into a vector representation. For example, data augmentation system 210 can convert the textual representations of dataset in external database 220 into vector representations using embedding. The words, phrase, or sentences of textual data can be transformed into numerical vectors. The converted vector representations (e.g., vector embeddings) can be used to find/identify relevant data using natural language processing.

The retriever 212 can identify and retrieve relevant data using a variety of methods such as textual, vector, hybrid, and/or semantic search. For example, a semantic search can be performed to determine datasets that may be relevant to user input 202 and may be used to generate output 240. The similarity search module 214 can use the converted vector representations to determine relevant data in external database 220. For example, similarity search module 214 can identify closely positioned vectors to determine relevant data in external database 220, enabling semantic search. Specifically, similarity search module 214 may determine a vector distance or cosine similarity between vector embeddings representing textual data in external database 220 and vector embeddings from user input 202 or a search query that is generated based on user input 202. For example, a vector distance (e.g., Euclidean distance) between vectors representing the data associated with user input 202 and vectors representing the data in external database 220. In another example, a cosine similarity can be used to measure how similar two vectors are by calculating the cosine of the angle between the vectors representing textual data associated with user input 202 and vectors representing textual data in external database 220.

Based on respective vector distances or cosines of the angle between vectors representing textual data associated with user input 202 and vectors representing textual data in the external database 220 in comparison to the similarity threshold, similarity search module 214 can identify relevant datasets in external database 220 that can be used in generating output 240 in response to user input 202. If a vector distance or cosine of the angle is below a similarity threshold, similarity search module 214 can identify the data as relevant to generating output 240. If a vector distance or cosine of the angle is above a similarity threshold, similarity search module 214 can identify the data as irrelevant and not needed for generating output 240.

In some implementations, a similarity threshold can be dynamically configured based on various parameters such as a user preference, information availability (e.g., an amount of data available in external database 220), and so on. For example, a similarity threshold can be user-configurable based on user's preference. In another example, if data availability in external database 220 is low, a similarity threshold can be lowered to capture the relevant data.

In some embodiments, a bias or a weight can be applied to a portion of data in external database 220 based on a date of an update or modification. For example, similarity search module 214 can put a bias or a weight toward recent data (e.g., data that is added or modified within a threshold time window) compared to outdated data, which may not be as relevant as the recent data for generating output 240. In another example, a frequency bias can be applied to a portion of data in external database 220 to prioritize results that occur more often in the dataset (e.g., external database 220). For example, if vulnerabilities with similar characteristics (e.g., Java dependency issues) frequently map to specific mitigation, they can be prioritized over isolated events when retrieving relevant data from external historical vulnerability database.

Further, relevant data can be identified based on various considerations such as a type of vulnerability, a type of asset worked on, relevant department (e.g., protocols, standards, etc.), a location, a language, a description of problem, or a combination thereof.

The relevant data identified in or retrieved from external database 220 can be provided to prompt generator 216. As previously described, prompt generator 216 is configured to generate an input for a trained AI model 230 (e.g., a prompt) based on user input 202 and the relevant data identified in external database 220.

In some implementations, the relevant data (e.g., data retrieved from external database 220) can be embedded into a prompt for trained AI model 230. For example, prompt generator 216 can map the relevant data in the prompt for trained AI model 230. In some examples, based on the relevant data embedding in the prompt, trained AI model 230 may identify a pattern(s) and use the pattern to generate output 240 (e.g., predictions). For example, based on the relevant data retrieved from external database 220, trained AI model 230 can effectively generate a rule to generate output 240.

In some examples, data augmentation system 210 can identify a pattern in the relevant data retrieved from external database 220. As follows, data augmentation system 210 can embed the pattern in the input for the trained AI model 230 such that a pattern or behavior that is not built into the trained AI model 230, as the pattern may be particular to a specific entity, can improve the accuracy of predictions of trained AI model 230.

The trained AI model 230 can generate output 240 using the prompt from prompt generator 216, which includes additional information associated with user input 202 and retrieved from external database 220. In other words, the trained AI model 230 can leverage the augmented data that the trained AI model 230 has not previously seen and generate output 240 (e.g., a response to user input 202) based on expansive and contextual information.

In some implementations, output 240 can include a prediction in response to user input 202 and additional information associated with the prediction. The output 240 can further include, for example and without limitation, a reference to a source corresponding to the external and/or contextual information in external database 220 (e.g., relevant historical records), past predictions in the relevant or similar scenarios, a reason for predicting the outcome, and so on. The expansive and contextual information retrieved from external database 220 may enable the trained AI model 230 to generate not only a more informed prediction but also a compressive overcome of the prediction.

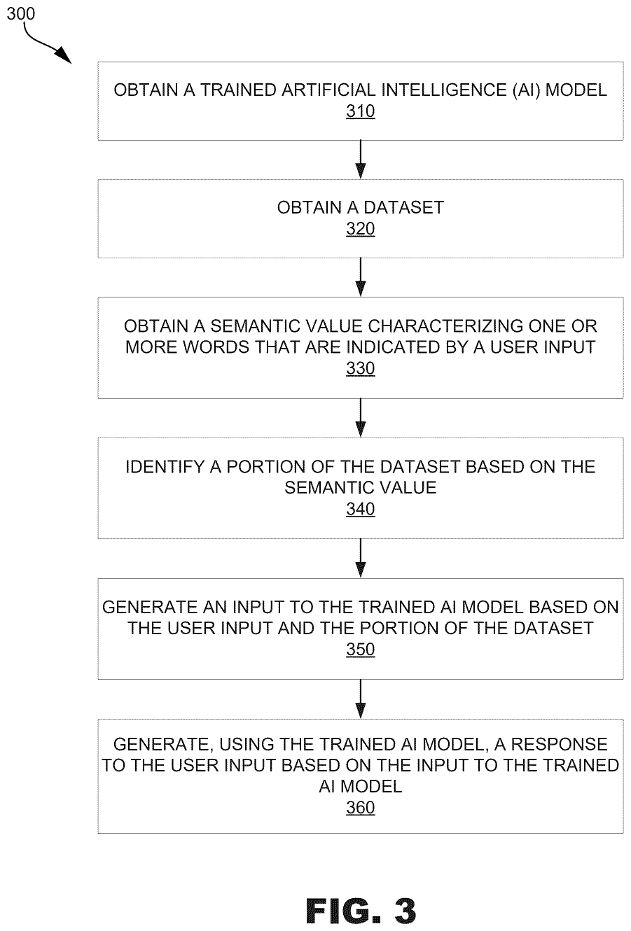

FIG. 3 illustrates a flowchart of an example method 300 for augmenting data for a trained AI model to generate a response to a user input by leveraging external historical records, according to some examples of the present disclosure. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIG. 2. However, method 300 is not limited to that example.

At step 310, method 300 includes obtaining a trained AI model. For example, data augmentation system 210 can obtain or access a trained AI model 230, which is configured to generate output 240 in response to user input 202. In some implementations, the trained AI model 230 b can be any applicable machine learning model (e.g., LLM) that includes a transformer architecture.

At step 320, method 300 includes obtaining a dataset. For example, data augmentation system 210 can obtain or access external database 220, which is configured to store external datasets such as entity-specific information (e.g., customer vulnerability data or customer security incident data that may be specific to a particular entity), domain-specific information, up-to-date information, and so on.

As previously described, a trained AI model 230 was trained with a corpus of data that is different from data stored in external database 220. As follows, trained AI model 230 has not seen the datasets stored in external database 220. In some implementations, the datasets stored in the external database 220 may have a schema structure or format that is different from the structure of training data that the trained AI model 230 has been trained on.

At step 330, method 300 includes obtaining a semantic value characterizing one or more words. The one or more words can be indicated by a user input. For example, data augmentation system 210 can obtain a semantic value characterizing words that are associated with user input 202. As previously described, various fields (e.g., title, name, description, summary, type, category, date, etc.) associated with user input 202 can be extracted to provide semantic value(s) characterizing one or more words associated with user input 202.

At step 340, method 300 includes identifying a portion (e.g., less than the entirety) of the dataset based on the semantic value. For example, data augmentation system 210 or similarity search module 214 may determine that the portion of the dataset in external database 220 and the semantic value associated with user input 202 together satisfy a semantic similarity criterion. The data augmentation system 210 can determine a vector distance or cosine similarity between vector embeddings representing textual data in external database 220 and vector embeddings associated with user input 202. The similarity search module 214 can identify relevant datasets in external database 220 that can be used in generating output 240 in response to user input 202 if a vector distance or cosine of the angle is below a similarity threshold. A semantic similarity search as described herein is technically advantageous because a semantic search may interpret the intent, related concepts, and language nuances in the query to deliver more relevant and accurate results unlike traditional keyword-based search, which retrieves results based on exact term matching. For example, the semantic similarity search includes determining an understanding or a meaning regarding the dataset.

In some embodiments, the trained AI model 230 can be characterized by operational values (e.g., weights) associated with a particular context such as a vulnerability response. As follows, the portion of the dataset can be identified by determining that the portion of the dataset is associated with or relevant to the particular context of the trained AI model.

At step 350, method 300 includes generating an input to the trained AI model based on the user input and the portion of the dataset. For example, the relevant datasets retrieved from external database 220 can be embedded into the input to the trained AI model 230. Providing the AI model with selected domain-specific knowledge can be technically advantageous and helpful to generate a prediction with improved accuracy. In other words, incorporating information from external sources directly into the prompt is technically advantageous as it enables the model (e.g., trained AI model 230) to generate a more accurate and contextually relevant response. The prediction (e.g., output 240) of the model can have improved accuracy and relevance by pulling in specific/targeted, up-to-date information from a database that the model has not seen previously.

At step 360, method 300 includes generating, using the trained AI model, a response to the user input based on the input to the trained AI model. For example, trained AI model 230 can generate output 240 in response to user input 202 based on the relevant data retrieved from external database 220. In some embodiments, output 240 can include, in addition to a prediction in response to user input 202, a source corresponding to the historical/relevant data, an outcome predicted based on the user input 202 and the historical/relevant data, and a reason for predicting the outcome. By providing the model with new/recent or modified information and domain-specific, factual knowledge from an external source, the present disclosure offers a technical advantage as the model can generate a comprehensive analysis and verifiable output.

Further, incorporating information from external sources instead of computationally costly (e.g., high processing costs) and time-consuming fine-tuning or retraining provides a technical advantage since the present technique is model-agnostic and can be applied to any machine learning model that has a transformer architecture without having to make any changes to the model's pre-trained weights.

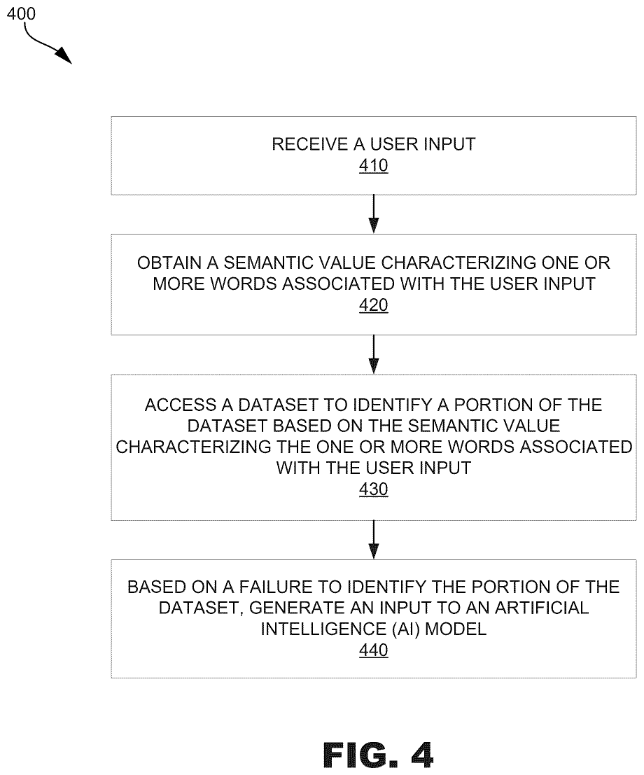

FIG. 4 illustrates a flowchart of an example method 400 for generating an input to an AI model based on a lack of the relevant historical data, according to some examples of the present disclosure. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 400 shall be described with reference to FIG. 2. However, method 400 is not limited to that example.

At step 410, method 400 includes receiving a user input. For example, data augmentation system 210 may receive user input 202, which includes a request for prediction. As previously illustrated, user input 202 may include a query regarding a particular vulnerability item associated with an entity. For example, user input 202 may request a prediction, recommended remediation(s), and/or a description of the vulnerability item.

At step 420, method 400 includes obtaining a semantic value characterizing one or more words associated with the user input. For example, data augmentation system 210 may obtain a semantic value characterizing words associated with user input 202. The data augmentation system 210 may evaluate and analyze various fields (e.g., title, name, description, summary, type, category, date, etc.) associated with user input 202 to obtain the semantic value(s). Based on the contextual information extracted from these fields, data augmentation system 210 can have a semantic understanding of one or more words associated with user input 202.

At step 430, method 400 includes accessing a dataset to identify a portion of the dataset based on the semantic value characterizing the one or more words associated with the user input. For example, data augmentation system 210 may access external database 220, which stores external knowledge such as up-to-date information, domain-specific information, entity-specific information, or proprietary data that is associated with a particular entity such as updated regulations, policies specific to a particular entity, etc. The external database 220 may include entity-specific historical records that may be associated with user input 202 (e.g., past vulnerability data associated with an entity of a user who provided the user input 202).

In some embodiments, data augmentation system 210 may access external database 220 to determine if any portion of the dataset in external database 220 may be relevant to or contain information for generating output 240 (e.g., a prediction in response to user input 202). Specifically, data augmentation system 210 may perform a semantic similarity search as illustrated with respect to FIGS. 2 and 3 to locate the relevant data, for example by measuring a vector distance or cosine of angles between vector(s) representing the data associated with user input 202 and vector(s) representing the external data stored in external database 220.

In some implementations, data augmentation system 210 may determine that none of the datasets in external database 220 is relevant to user input 202 or not needed in generating output 240. For example, data augmentation system 210 may determine that vector distance(s) or cosine(s) of angles do not exceed a similarity threshold.

At step 440, method 400 includes generating an input to an AI model based on a failure to identify the portion of the dataset. The portion of the dataset may be a sub-portion (e.g., less than the entirety of the dataset). For example, data augmentation system 210 may generate an input to trained AI model 230. Upon determining that external database 220 lacks any relevant data to be retrieved, data augmentation system 210 may generate an input to trained AI model 230 that reflects the lack of relevant data (e.g., lack of example historical data). A machine learning model has a risk of hallucination when the model lacks enough relevant data or context to provide a factual response, leading it to improvise or hallucinate (e.g., generate incorrect or fabricated predictions) based on patterns learned from its training data. Therefore, including an instruction or a guide in an input to trained AI model 230 regarding the lack of relevant historical data can be technically advantageous and prevent or reduce a hallucination produced by the model. Rather than relying on insufficient or irrelevant training data, trained AI model 230 can generate, based on the instruction or guide regarding the lack of relevant historical data, an output (e.g., output noting the inability of make a prediction in response to user input 202).

The disclosure now turns to a further discussion of example software models and devices that can be used to implement the technologies described herein.

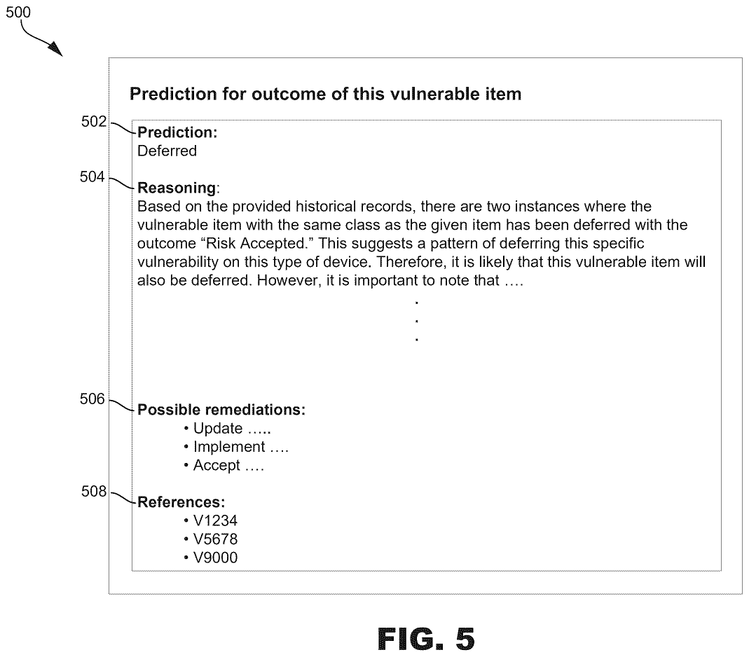

FIG. 5 illustrates an example output 500 of prediction for a vulnerability item, according to some examples of the present disclosure. In this example, trained AI model 230 can generate output 240 that includes a prediction for outcome of the inquired vulnerability item, for example in response to user input 202 that may request a prediction for a vulnerability item.

In some embodiments, data augmentation system 210 as illustrated in FIG. 2 can be implemented as part of a vulnerability response tool, which is configured to evaluate and analyze a vulnerability (e.g., a vulnerability item indicated in user input 202) and provide output 500 including a prediction of an outcome of the vulnerability item. For example, data augmentation system 210 can access internal and/or external sources such as external database 220, which stores vulnerability data, historical records of vulnerabilities, and/or any information or data regarding known vulnerabilities and exposures associated with an entity.

The output 500 may include, in addition to prediction 502, various items providing additional information relating to the prediction such as reasoning 504, possible remediations 506, and references 508. The reasoning 504 can provide an analysis of the prediction 502 based on the historical records retrieved from external database 220. The analysis can include statistics of outcomes of relevant historical records identified in external database 220, a probability of different outcomes of the inquired vulnerability item, and so on. Further, reasoning 504 can include a description of a pattern identified in the relevant historical records.

In some implementations, output 500 can include a description of the inquired vulnerability item (not shown in FIG. 5), which provides information about a specific vulnerability item (e.g., security weakness in a system, application, or network) to help users understand the nature, impact, and potential risks associated with the vulnerability item. The description of the vulnerability can include, for example and without limitation, title/name of the vulnerability, vulnerability unique identifier (ID), summary, affected systems or components, severity rating, impact, reporting date, and so on.

The output 500 may include possible remediations 506, which provides suggested actions that can be taken in response to the predicted outcome of the vulnerability item. For example, the possible remediations 506 can include recommendations for addressing the vulnerability such as applying patches, updating configurations, modifying code, accepting the risk, temporary workarounds, and so on.

The references 508 can provide a source of information in the historical records that trained AI model 230 has used to generate an output (e.g., prediction 502). For example, references 508 can include links or citations to historical records that provide further context or support remediation efforts.

As previously described, leveraging expansive datasets (e.g., historical records from external database), the present disclosure offers numerous technical advantages. Specifically, a machine learning model can, based on the augmented data that contains information about past patterns and behaviors, make more informed predictions, thereby improving the accuracy of the predictions. Further, the augmented data based on external historical records help provide a comprehensive analysis and overview (e.g., example output 500 including extensive information such as prediction 502, reasoning 504, description of a vulnerability item, possible remediations 506, references 508, etc.).

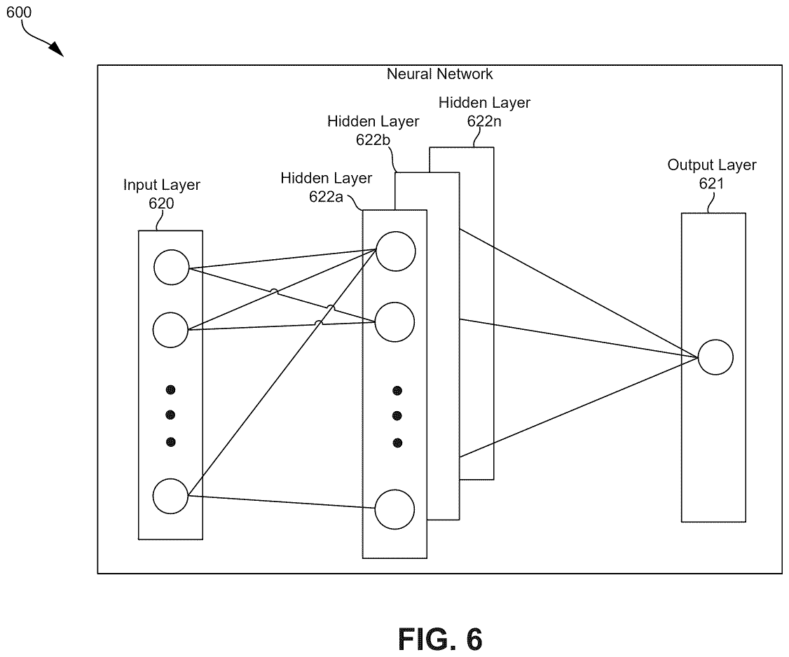

FIG. 6 is a diagram illustrating an example of a deep learning neural network 600 that can be used to implement all or a portion of the systems and techniques described herein, according to some examples of the present disclosure. For example, the neural network 600 can be used to implement trained AI model 230, an LLM deployed by retriever 212 and/or similarity search module 214, and/or any other model(s) described herein (and/or component thereof).

An input layer 620 can be configured to receive data such as data included in an input prompt(s), user input 202, a prompt generated by data augmentation system 210 and/or prompt generator 216, and/or any other data described herein. Neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. Neural network 600 further includes an output layer 621 that provides an output resulting from the processing performed by the hidden layers 622a, 622b, through 622n.

Neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 621, at which an output is provided. In some cases, while nodes in the neural network 600 are shown as having multiple output lines, a node can have a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 621.

In some cases, the neural network 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 600 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 600 can perform a backward pass by determining which inputs (weights) most contributed to the loss of the network, and can adjust the weights so that the loss decreases and is eventually minimized.

The neural network 600 can include any suitable deep network. One example neural network includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 600 can include any other deep network other than a CNN, such as a transformer, autoencoder, Deep Belief Net (DBN), Recurrent Neural Network (RNN), an encoder and/or decoder network, among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

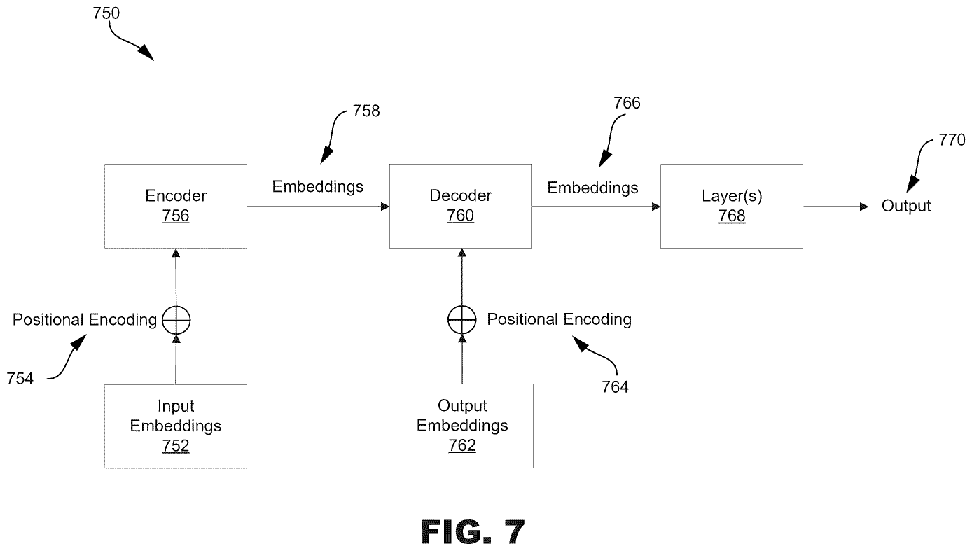

FIG. 7 is a diagram illustrating an example architecture of an example transformer model 750, according to some examples of the present disclosure. The transformer model 750 can be used to implement an LLM that can be used to implement the technologies described herein. For example, the transformer model 750 can be used to implement the trained AI model 230, an LLM deployed by retriever 212 and/or similarity search module 214, and/or any other software model(s) described herein (and/or component thereof).

As shown, the transformer model 750 can include input embeddings 752 used as inputs to the transformer model 750. The input embeddings 752 can include input values representing words and/or sentences, such as numbers or vectors representing words and/or sentences.

In some cases, the input embeddings 752 can function like a dictionary that helps the transformer model 750 understand the meaning of words by placing them in an embedding space where similar words are located near each other. In some examples, an input interface can be trained and/or configured to create the input embeddings 752 so that similar vectors represent words with similar meanings. In some examples, the transformer model 750 can additionally or alternatively learn to create and/or process the input embeddings 752 during training.

The transformer model 750 can use positional encoding 754 to encode the position of each word in an input sequence from the input embeddings 752 as values such as a set of numbers, a vector, etc. The values generated by the positional encoding 754 can be fed into the transformer model 750 along with the input embeddings 752. By incorporating the positional encoding 754 into the transformer model 750, the transformer model 750 can more effectively understand the order of words in a sentence and generate grammatically correct and semantically meaningful output.

The transformer model 750 can include an encoder(s) 756 used to process the positionally encoded input embeddings 752 and generate embeddings 758. The encoder(s) 756 can be part of the transformer model 750 that processes input text and generates hidden states that capture the meaning and context of the text. For example, the encoder(s) 756 can include a feed-forward neural network that is part of the transformer model 750. In some examples, the encoder(s) 756 can implement multiple encoder layers. In some cases, the encoder(s) 756 can first tokenize the input text into a sequence of tokens, such as individual words or subwords. The encoder(s) 756 can then apply one or more self-attention layers, which can generate hidden states that represent the input text at different levels of abstraction. In this way, the encoder(s) 756 can generate the embeddings 758 (e.g., a vector, a set of values, etc.) representing the semantics and position of words in one or more sentences.

The transformer model 750 can include output embeddings 762, which can include values representing words and/or sentences, such as numbers or vectors representing words and/or sentences. The output embeddings 762 can be similar to the input embeddings 752 and can also be processed by positional encoding 764 to encode the position of each word in a sequence from the output embeddings 762 as values such as a set of numbers, a vector, etc., which helps the transformer model 750 understand the order of words in a sentence. The output embeddings 762 can be used during a training phase of the transformer model 750 and can be used during an inference phase. During training, a loss function can be computed based on the output embeddings 762 and used to update the model parameters to improve the accuracy of the transformer model 750. During an inference phase, the output embeddings 762 can be used to generate the output text by mapping the predicted probabilities determined by the transformer model 750 for each token to the corresponding token in the vocabulary.

The positionally encoded input embeddings 752 (e.g., the embeddings 758) and the positionally encoded output embeddings 762 can be fed to a decoder(s) 760 used to generate the output sequence based on the encoded input sequence. During training, the decoder(s) 760 can learn how to guess the next word of a sequence by looking at the words before it. In some examples, the decoder(s) 760 can generate natural language text based on the input sequence and any learned context.

The decoder(s) 760 can generate embeddings 766 and feed the embeddings 766 to one or more network layers 768. In some examples, the one or more network layers 768 can include a linear layer and a softmax function. The linear layer can map the embeddings 766 generated by the decoder(s) 760 to a higher-dimensional space, which can transform the embeddings 766 into the original input space. The softmax function can then be applied to generate a probability distribution for each output token in the vocabulary, which can result in an output 770. In some examples, the output 770 can include output tokens with probabilities.

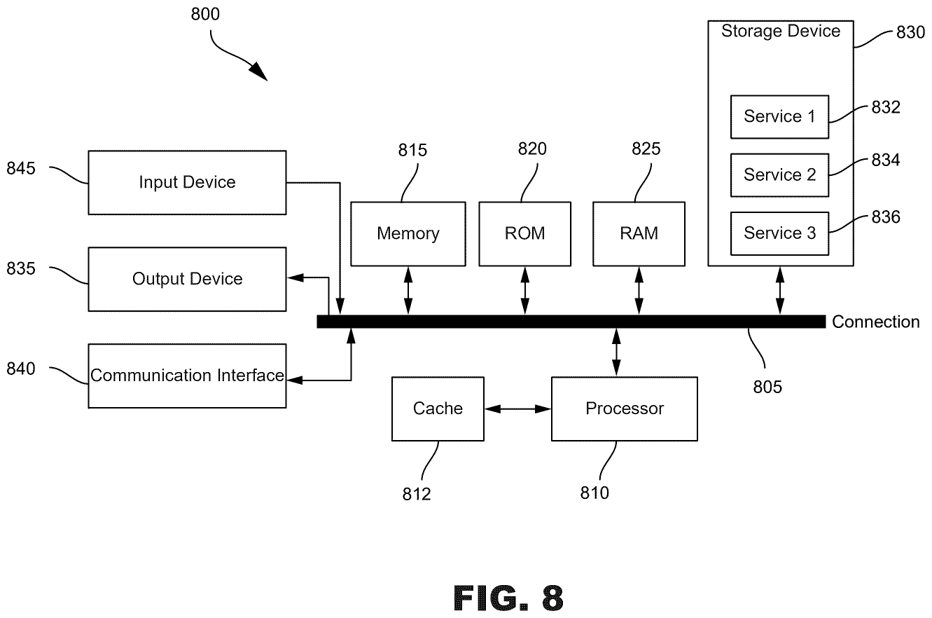

FIG. 8 illustrates an example processor-based system with which some aspects of the subject technology can be implemented. For example, processor-based system 800 can be any computing device making up the data augmentation system 210, any of the client devices 116, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some implementations, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the present disclosure include:
Aspect 1. A computer-implemented method comprising: obtaining a trained artificial intelligence (AI) model; obtaining a dataset; obtaining a semantic value characterizing one or more words, wherein the one or more words are indicated by a user input; identifying a portion of the dataset based on the semantic value; generating an input to the trained AI model based on the user input and the portion of the dataset; and generating, using the trained AI model, a response to the user input based on the input to the trained AI model.
Aspect 2. The computer-implemented method of Aspect 1, wherein the trained AI model includes operational values associated with a particular context.
Aspect 3. The computer-implemented method of Aspect 2, wherein identifying the portion of the dataset includes determining that the portion of the dataset is associated with the particular context.
Aspect 4. The computer-implemented method of any of Aspects 1 to 3, wherein the trained AI model was trained using a corpus of data that is different from the dataset.
Aspect 5. The computer-implemented method of any of Aspects 1 to 4, wherein identifying the portion of the dataset includes determining that the portion of the dataset and the semantic value together satisfy a semantic similarity criterion.
Aspect 6. The computer-implemented method of any of Aspects 1 to 5, wherein identifying the portion of the dataset based on the semantic value comprises: based on respective distances between one or more vectors representing the one or more words and vector embeddings representing textual data in the dataset, determining that a distance between the one or more vectors and a vector embedding from the vector embeddings is below a threshold, the vector embedding being associated with portion of the dataset; and identifying the portion of the dataset based on the determining that the distance between the one or more vectors and the vector embedding associated with the portion of the dataset is below the threshold.
Aspect 7. The computer-implemented method of Aspect 6, wherein the threshold is based on at least one of a user preference and an amount of data in the dataset.
Aspect 8. The computer-implemented method of any of Aspects 1 to 7, wherein generating the input to the trained AI model comprises embedding the portion of the dataset in the input to the trained AI model.
Aspect 9. The computer-implemented method of any of Aspects 1 to 8, wherein generating the input to the trained AI model comprises: identifying a pattern in the portion of the dataset; and embedding the pattern in the input to the trained AI model.
Aspect 10. The computer-implemented method of any of Aspects 1 to 9, wherein generating the input to the trained AI model comprises: applying a bias to a part of the portion of the dataset based on a date when the part of the portion of the dataset was collected; and generating the input to the trained AI model further based on the bias.
Aspect 11. A system comprising: one or more processors; and at least one computer-readable storage medium having stored therein instructions which, when executed by the one or more processors, cause the one or more processors to: obtain a trained artificial intelligence (AI) model; obtain a dataset; obtain a semantic value characterizing one or more words, wherein the one or more words are indicated by a user input; identify a portion of the dataset based on the semantic value; generate an input to the trained AI model based on the user input and the portion of the dataset; and generate, using the trained AI model, a response to the user input based on the input to the trained AI model.
Aspect 12. The system of Aspect 11, wherein the trained AI model includes operational values associated with a particular context.
Aspect 13. The system of Aspect 12, wherein identifying the portion of the dataset includes determining that the portion of the dataset is associated with the particular context.
Aspect 14. The system of any of Aspects 11 to 13, wherein the trained AI model was trained using a corpus of data that is different from the dataset.
Aspect 15. The system of any of Aspects 11 to 14, wherein identifying the portion of the dataset includes determining that the portion of the dataset and the semantic value together satisfy a semantic similarity criterion.
Aspect 16. The system of any of Aspects 11 to 15, wherein identifying the portion of the dataset based on the semantic value comprises: based on respective distances between one or more vectors representing the one or more words and vector embeddings representing textual data in the dataset, determining that a distance between the one or more vectors and a vector embedding from the vector embeddings is below a threshold, the vector embedding being associated with portion of the dataset; and identifying the portion of the dataset based on the determining that the distance between the one or more vectors and the vector embedding associated with the portion of the dataset is below the threshold.
Aspect 17. The system of any of Aspects 11 to 16, wherein generating the input to the trained AI model comprises embedding the portion of the dataset in the input to the trained AI model.
Aspect 18. The system of any of Aspects 11 to 17, wherein generating the input to the trained AI model comprises: identifying a pattern in the portion of the dataset; and embedding the pattern in the input to the trained AI model.
Aspect 19. The system of any of Aspects 11 to 18, wherein generating the input to the trained AI model comprises: applying a bias to a part of the portion of the dataset based on a date when the part of the portion of the dataset was collected; and generating the input to the trained AI model further based on the bias.
Aspect 20. A non-transitory computer-readable medium having stored thereon instructions which, when executed by one or more processors, cause the one or more processors to perform a method according to any of Aspects 1 to 10.
Aspect 21. A system comprising means for performing a method according to any of Aspects 1 to 10.
Aspect 22. A computer-program product having stored thereon instructions which, when executed by one or more processors, cause the one or more processors to perform a method according to any of Aspects 1 to 10.

What is claimed is:

1. A computer-implemented method comprising:
obtaining a trained artificial intelligence (AI) model;
obtaining a dataset;
obtaining a semantic value characterizing one or more words, wherein the one or more words are indicated by a user input;
identifying a portion of the dataset based on the semantic value;
generating an input to the trained AI model based on the user input and the portion of the dataset; and
generating, using the trained AI model, a response to the user input based on the input to the trained AI model.

2. The computer-implemented method of claim 1, wherein the trained AI model includes operational values associated with a particular context.

3. The computer-implemented method of claim 2, wherein identifying the portion of the dataset includes determining that the portion of the dataset is associated with the particular context.

4. The computer-implemented method of claim 1, wherein the trained AI model was trained using a corpus of data that is different from the dataset.

5. The computer-implemented method of claim 1, wherein identifying the portion of the dataset includes determining that the portion of the dataset and the semantic value together satisfy a semantic similarity criterion.

6. The computer-implemented method of claim 1, wherein identifying the portion of the dataset based on the semantic value comprises:
based on respective distances between one or more vectors representing the one or more words and vector embeddings representing textual data in the dataset, determining that a distance between the one or more vectors and a vector embedding from the vector embeddings is below a threshold, the vector embedding being associated with portion of the dataset; and
identifying the portion of the dataset based on the determining that the distance between the one or more vectors and the vector embedding associated with the portion of the dataset is below the threshold.

7. The computer-implemented method of claim 6, wherein the threshold is based on at least one of a user preference and an amount of data in the dataset.

8. The computer-implemented method of claim 1, wherein generating the input to the trained AI model comprises embedding the portion of the dataset in the input to the trained AI model.

9. The computer-implemented method of claim 1, wherein generating the input to the trained AI model comprises:
identifying a pattern in the portion of the dataset; and
embedding the pattern in the input to the trained AI model.

10. The computer-implemented method of claim 1, wherein generating the input to the trained AI model comprises:
applying a bias to a part of the portion of the dataset based on a date when the part of the portion of the dataset was collected; and
generating the input to the trained AI model further based on the bias.

11. A system comprising:
one or more processors; and
at least one computer-readable storage medium having stored therein instructions which, when executed by the one or more processors, cause the one or more processors to:
obtain a trained artificial intelligence (AI) model;
obtain a dataset;
obtain a semantic value characterizing one or more words, wherein the one or more words are indicated by a user input;
identify a portion of the dataset based on the semantic value;
generate an input to the trained AI model based on the user input and the portion of the dataset; and
generate, using the trained AI model, a response to the user input based on the input to the trained AI model.

12. The system of claim 11, wherein the trained AI model includes operational values associated with a particular context.

13. The system of claim 12, wherein identifying the portion of the dataset includes determining that the portion of the dataset is associated with the particular context.

14. The system of claim 11, wherein the trained AI model was trained using a corpus of data that is different from the dataset.

15. The system of claim 11, wherein identifying the portion of the dataset includes determining that the portion of the dataset and the semantic value together satisfy a semantic similarity criterion.

16. The system of claim 11, wherein identifying the portion of the dataset based on the semantic value comprises:
based on respective distances between one or more vectors representing the one or more words and vector embeddings representing textual data in the dataset, determining that a distance between the one or more vectors and a vector embedding from the vector embeddings is below a threshold, the vector embedding being associated with portion of the dataset; and
identifying the portion of the dataset based on the determining that the distance between the one or more vectors and the vector embedding associated with the portion of the dataset is below the threshold.

17. The system of claim 11, wherein generating the input to the trained AI model comprises embedding the portion of the dataset in the input to the trained AI model.

18. The system of claim 11, wherein generating the input to the trained AI model comprises:
identifying a pattern in the portion of the dataset; and
embedding the pattern in the input to the trained AI model.

19. The system of claim 11, wherein generating the input to the trained AI model comprises:
applying a bias to a part of the portion of the dataset based on a date when the part of the portion of the dataset was collected; and
generating the input to the trained AI model further based on the bias.

20. A non-transitory computer-readable medium having stored thereon instructions which, when executed by one or more processors, cause the one or more processors to:
obtain a trained artificial intelligence (AI) model;
obtain a dataset;
obtain a semantic value characterizing one or more words, wherein the one or more words are indicated by a user input;
identify a portion of the dataset based on the semantic value;
generate an input to the trained AI model based on the user input and the portion of the dataset; and
generate, using the trained AI model, a response to the user input based on the input to the trained AI model.
